(19) United States
(12) Patent Application Publication
(10) Pub. No.: US 2017/0053304 A1
(43) Pub. Date: Feb. 23, 2017

(54) DETERMINATION OF ATTENTION TOWARDS STIMULI BASED ON GAZE INFORMATION

(71) Applicants: TOBII AB, Falls Church, VA (US); STICKY, INC., San Francisco, CA (US)

(72) Inventors: Henrik ESKILSSON, Danderyd (SE); Markus CEDERLUND, Sollentuna (SE); Hans LEE, Carmel, CA (US); Magnus LINDE, Stockholm (SE)

(21) Appl. No.: 15/307,261

(22) PCT Filed: Apr. 28, 2015
(86) PCT No.: PCT/US2015/027990

§ 371 Date: Oct. 27, 2016

Related U.S. Application Data
(60) Provisional application No. 61/985,212, filed on Apr. 28, 2014.
(60) Provisional application No. 62/080,850, filed on Nov. 17, 2014.

(51) Int. Cl. G06Q 30/02; G06F 17/30

(52) U.S. Cl. CPC G06Q 30/0242; G06F 17/30864; G06K 9/00281

(57) ABSTRACT

A method for determining a relationship between biometric data and stimuli to reach a conclusion is disclosed. The method may include associating displayed stimuli with an identity label. The method may also include collecting biometric data relative to displayed stimuli. The method may further include attributing a rating to the displayed stimuli based on the biometric data. The method may additionally include associating the rating with the identity label.

### CROSS REFERENCE TO RELATED APPLICATIONS

This application claims priority to Provisional U.S. Patent Application No. 62/080,850 filed Nov. 17, 2014, entitled “DETERMINATION OF ATTENTION TOWARDS STIMULI BASED ON GAZE INFORMATION” and Provisional U.S. Patent Application No. 61/985,212 filed Apr. 28, 2014, entitled “SYSTEMS AND METHODS FOR ONLINE INFORMATION ANALYSIS.” The entire disclosure of both of the aforementioned Provisional U.S. Patent Applications are hereby incorporated by reference, for all purposes, as if fully set forth herein.

### BACKGROUND OF THE INVENTION

Embodiments of the present invention generally relates to systems and methods for the usage of gaze information to determine attention towards stimuli.

There exists many methods and systems for analyzing a user's gaze to determine their interest in, or attention towards, stimuli. These systems and methods may utilize dedicated gaze determination devices such as eye trackers, computing equipment such as a webcam or the like, and/or other cameras and sensors.

These methods and systems require dedicated setup by a user in many cases and they do not function seamlessly such that a user's experience is not somehow limited. Further, the owner or creator of the stimuli requires more detailed information and better access to the information than is currently provided.

Embodiments of the present invention seeks to provide improvements to known systems and methods, thus enabling an improved experience for the user and improved information for the stimuli owner or creator.

### BRIEF DESCRIPTION OF THE DRAWINGS

The present invention is described in conjunction with the appended figures:

FIG. 1 is a representation of metadata according to some embodiments of the present invention;

FIG. 2 is a system architecture diagram according to some embodiments of the present invention;

FIG. 3 is an example of templates for a study;

FIG. 4 is a representation of a creation dialogue for a study based off a template;

FIG. 5 shows a video file that may be used as part of a study;

FIG. 6 shows a dashboard for analyzing the results of an example study;

FIG. 7 is a listing showing three studies available for view, along with their associated gaze-heat maps;

FIG. 8 is representation of Areas of Interest (AOIs) overlayed over a media file; and

FIG. 9 is a block diagram of an exemplary computer system capable of being used in at least some portion of the apparatuses or systems of the present invention, or implementing at least some portion of the methods of the present invention.

In the appended figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DESCRIPTION OF THE INVENTION

The ensuing description provides exemplary embodiments only, and is not intended to limit the scope, applicability or configuration of the disclosure. Rather, the ensuing description of the exemplary embodiments will provide those skilled in the art with an enabling description for implementing one or more exemplary embodiments. It being understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other elements in the invention may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but could have additional steps not discussed or included in a figure. Furthermore, not all operations in any particularly described process may occur in all embodiments. A process may correspond to a method, a function, a procedure, a subroutine, a subprogram, etc. When a process corresponds to a function, its termination corresponds to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments of the invention may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Embodiments of the present invention provide efficient systems and methods for determining an interest in, or attention to, displayed stimuli. This and other objects of embodiments of the present invention will be made apparent from the specification, claims, and appended drawings.

In one embodiment, a method for determining biometric data relative to displayed media or stimuli is provided. The method may include arranging a study comprised of displaying media or stimuli on a computing device; displaying media or stimuli on a computing device; measuring biometric data relative to the media or stimuli displayed; processing the measured biometric data; and presenting conclusions gained from the measurement of the biometric data.

Further, any step of the above method may be conducted on more than one computing device at a location or time separate from any other step in the method. Additionally, the computing devices may be remote and geographically separate. Finally, more than one person may collaborate on any step in the method.

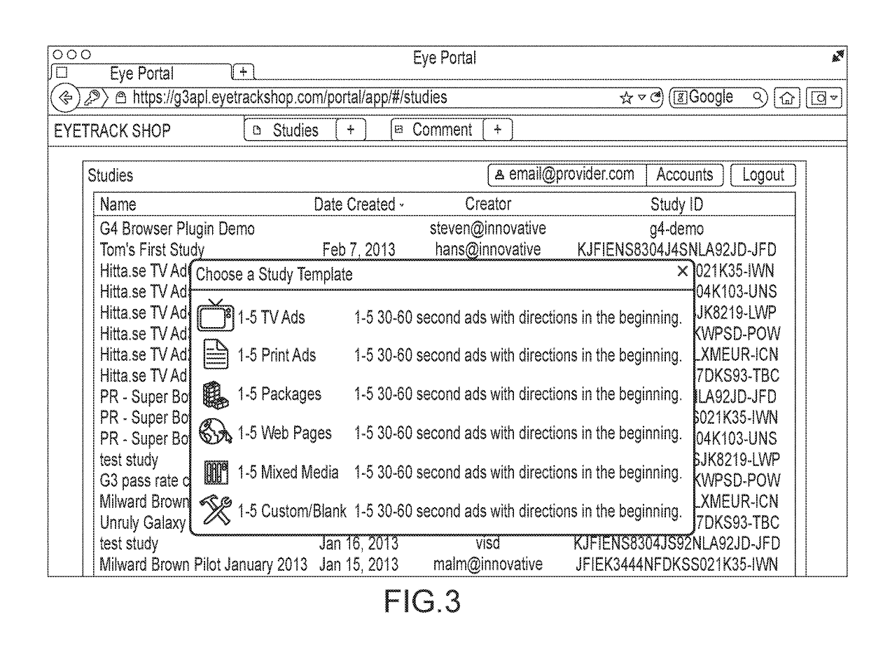

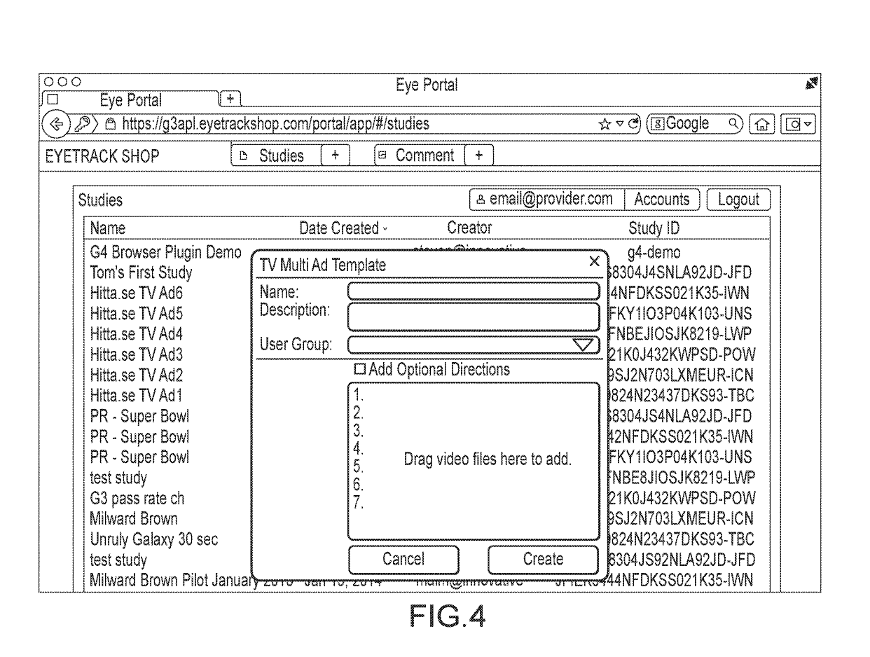

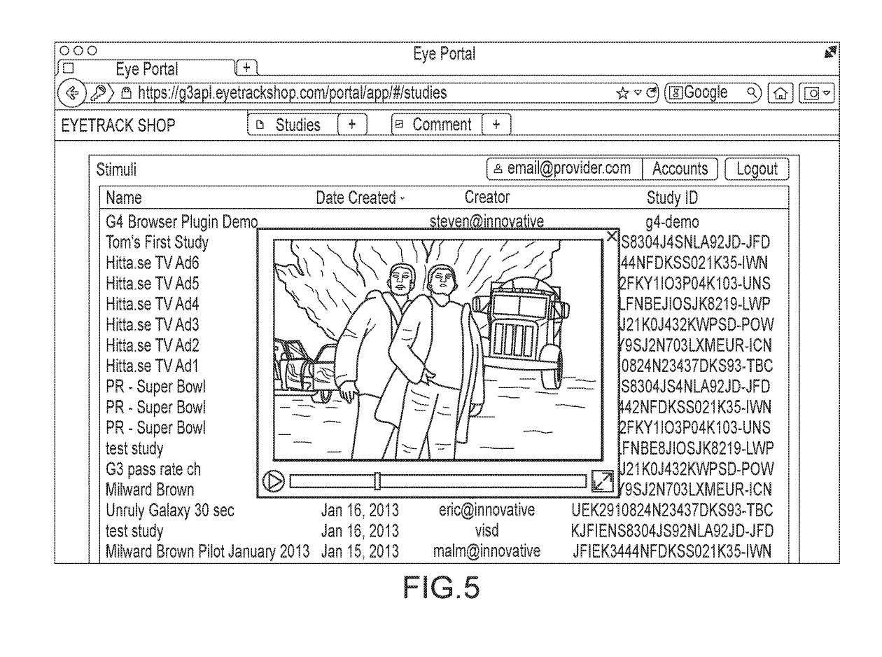

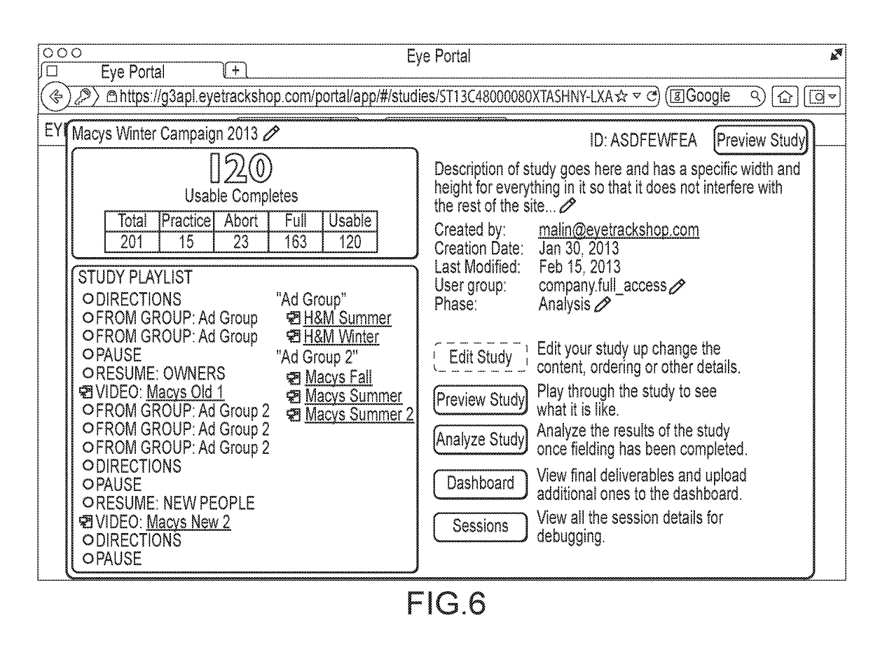

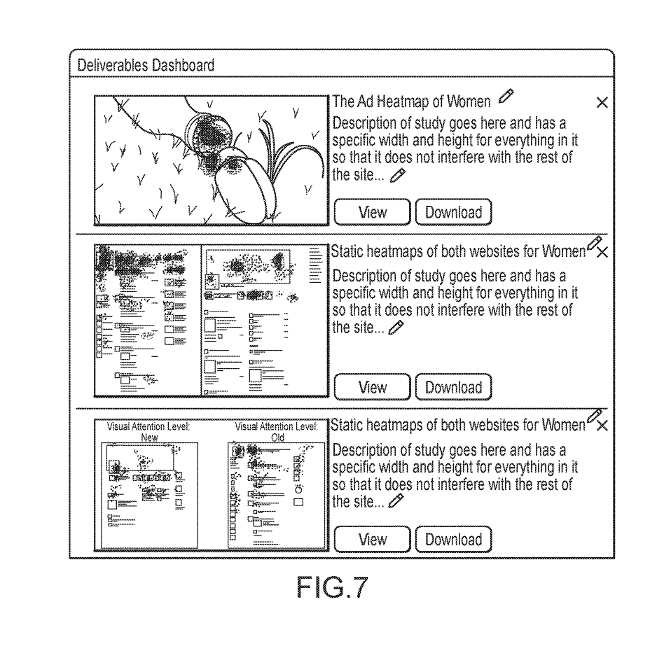

A study comprises at least one person and may be performed locally or remotely. For example a study may comprise an interaction through a web browser or application. A study may be defined by a template as shown in FIG. 3 and edited as shown in FIG. 4. FIG. 5 shows a video file that may be used as part of a study. FIG. 6 shows a dashboard for analyzing the results of an example study. FIG. 7 is a listing showing three studies available for view, along with their associated gaze-heat maps;

Object Markers

In one embodiment there is provided a method for analyzing a content source and marking items with key metadata. The metadata would be in a form readily understood by a person skilled in the art and will include, but is not limited to, location, depth, type, business attributes (e.g., company, field, products), advertisement network, and/or video game element. The items may include images, text, animation, computer or phone applications, real world interactions, other interactions, or a combination thereof.

The process of marking items with metadata is performed manually, whereby the depth, x and y positions of the items are recorded and named. Other properties of an item may also be recorded and named, including but not limited to visibility, color and content. The name is provided in metadata form also and is linked to a database. It is preferable that at least some of the metadata is refreshed upon the metadata changing. To explain, the items are constantly polled and upon a change to the item, the metadata is changed accordingly. For example, in the case of a website where an image has been tagged with metadata, the tagged items are constantly polled. If the x or y coordinates of a tagged item changes, then the metadata of that item is updated accordingly. This allows for tracking of objects even if they change in size, shape or location.

The process of marking items may be further improved on by utilising a template, for example a pre-determined layout of a website. This may allow automatic marking of items located in pre-determined locations i.e. a top banner advertisement.

Once items have been tagged, they can be corresponded with gaze, time and other biometric data according to some embodiments of the present invention. These various types of information may be provided by multiple systems.

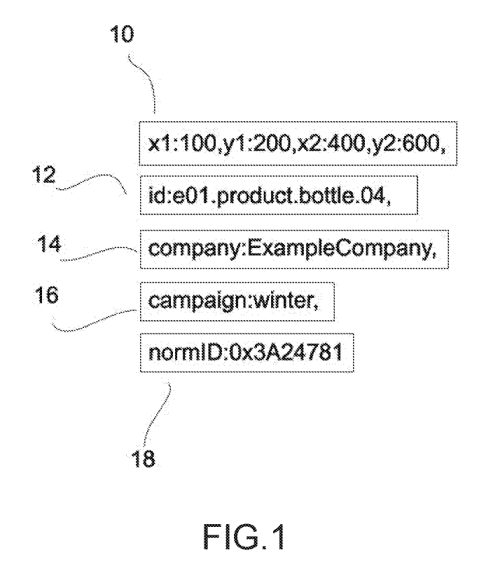

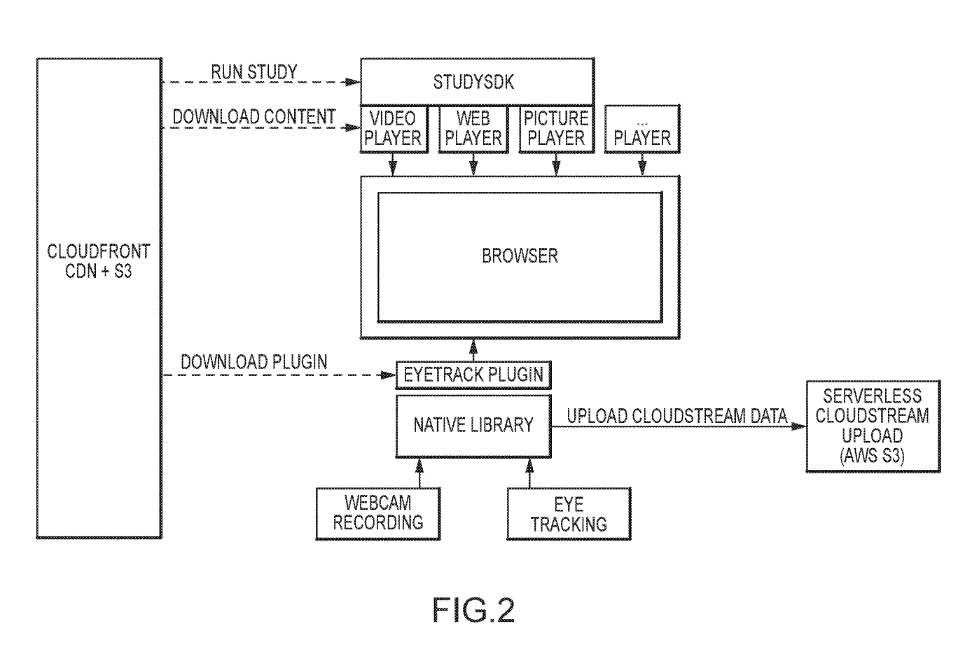

FIG. 1 shows an example of metadata according to some embodiments of the present invention. Item 10 represents x and y coordinates, 12 represents an identifier for the tagged item, 14 represents the company owning the tagged item, 16 represents an identifier for the advertising campaign the item belongs to and 18 represents an identifier for an external database. FIG. 2 shows a system architecture diagram according to any number of possible embodiments of the present invention.

The tag or marker may be for example a text string, a number, or any other identifier inserted into a web page, in close relation to an element of a web page, in a software or in video game. Software executed on a computing device may collect information about relevant tags and their element's precise location on the display at all times, and correlate this to gaze data and other data collected on the computing device.

For clarification, this aspect of the present invention will be further described with reference to an example. Consider a web page defined by Hyper Text Markup Language (HTML), downloaded from a web server to a web browser. The web page consists of a code snippet/Javascript code as well as a body containing some information and at least one tagged advertisement banner element. The tagged banner is embedded into the web page together with an ID of the banner as well as a URL directing to a web service where gaze data should be uploaded. The Javascript code detects the tag and requests a connection to the eye tracker to obtain gaze direction data. On a successful connection to the eye tracker, the Javascript code also creates a connection to the web service where to the gaze data should be uploaded. On successful connection to the web service the Javascript snippet then continuously monitor the position of the banner on the display, monitor the gaze data, and uploads relevant information to the recording server as soon as the gaze direction is towards the banner.

Implementing this method on a large scale allows the software to reliably collect information from a wide variety of advertisements on a wide variety of websites and software with a wide variety of gaze information, even when the presented information is highly dynamic in nature. This information may be collected, combined, analyzed and reported on to provide meaningful metrics on the efficiency of advertisements.

External Database

According to one aspect of the present invention, there may be provided a database of advertisements with single or multiple specific layouts for each uniquely identifiable advertisement, preferably each uniquely identifiable advertisement is associated with a global advertisement identifier. During use of a computing device, particularly when the specific software such as a web browser is used, advertisement shown to a user are extracted and their layout/visual design matched to the above-mentioned database in order to identify specific advertisements as having a particular global advertisement identifier. Determination of this match may be performed through software installed natively on a user's computing device, or hosted online. The software may use a variety of techniques to analyze the layout of a webpage and determine a match, these techniques include Optical Character Recognition (OCR), pattern matching and Computer Vision techniques. Preferably the match can be an exact or approximate match. Implementation of a suitable technique would be understood by a person skilled in the art.

For further clarification, this aspect of the present invention will now be described with reference to a specific example regarding displaying of elements of interest on a website. In this example, the elements of interest are advertisements.

Typically, websites are written using the Hyper Text Markup Language (HTML). HTML defines every object displayed on a website, typically in the case of advertisements the HTML code may simply define the position and a reference to an advertising provider. The advertising provider software or database selects the specific advertisement to be displayed on the website.

It is desirable to know the specific identity of an advertisement displayed without access to the advertising provider's software or database. It is therefore necessary to utilize a technique such as capturing an image of the advertisement and using a computer algorithm to match the image to a database of known advertisements. Another matching method may be to match a specific frame in a video to known frames of other videos in the database.

Once an advertisement has been matched, the software or browser is able to collect information relating to a user's gaze direction towards that advertisement. This information may be stored locally or sent to another location for analysis.

With reference to FIG. 2, this aspect of the present invention will now be described.

An item or items are displayed on a display, for example this may be via a browser or compiled software. At least a portion of a displayed item is sent by software according to the present invention to a database. In some instances an entire copy of the displayed item may be sent to the database. The portion may be captured using a technique previously described, or it may be captured using any known technique.

The portion of the displayed item is compared to a local database or sent to an online database for comparison. If a match is found between the portion and an entry in the database, information associated with that entry is provided to the software according to the present invention. This information may be identifying information or the like and may be used by the software to register gaze data relative to the displayed item.

If there is no match found between the portion of the displayed item and the database, the portion or the entirety of the displayed item may be entered into the database for further analysis and/or classification.

User Browsing Behavior

Software installed on a user's computing device or hosted online may continuously track a user's attention as represented by their gaze direction while a user is using a computing device. This attention information may be sent to a database. The information includes:
Identifying information for an advertisement
Gaze information such as raw gaze data, filtered gaze data such as fixations on an advertisement, time to fixation on an advertisement and the like
Other data such as galvanic skin response, pupil dilation, heartrate, EEG, face expressions and the like, while looking at an advertisement

Preferably this information is collected and uploaded to the database while a user performs normal activities, in other words the user does not alter their behavior based on the fact that information is being collected and sent to a database.

The collected information may be combined to build a metric representing a user's browsing behavior. The metric may define information such as the proportion of time a user spends looking at certain information (e.g., specific advertisements), the time taken to look at certain information, the number of times a user repeatedly looks at the same information. Further, the metric may show modifying information such as a user's emotional state while gazing at an element of interest.

User Consent

According to one embodiment of the present invention, software installed on a user's computing device or hosted online may, upon a user visiting a predetermined website, display to the user information asking if the user would like to allow their gaze direction to be determined while the user views the website. If the user consents to this taking place, gaze direction information is collected for a predetermined period.

This consent may be requested and granted on different levels, for example the user may be asked to consent to gaze direction information gathering to take place for a single website, a single browser session, everything from a certain domain or everything from a particular provider network such as Google AdWords.

Targeted Advertising

According to the present invention, information on a display may be arranged in order to display specific information to specific users. For example, once a user's gaze direction is known and the identity of the user is known, specific information may be displayed to that user.

This may be used to ensure certain users and demographics receive certain types of advertisements, for instance to perform comparative A/B testing whereby one alternative advertisement design is shown to portion of relevant users, and a second alternative advertisement is shown to a second portion, in order to measure and evaluate the difference in response evoked by the two alternatives.

A further improvement of the present invention is removing advertisements once a user has gazed at them for a predetermined period of time. This is beneficial as the user is then provided with a display comprising less advertisements.

A further improvement of the present invention is to start playing a video or other moving image once it has been gazed at by a user for a predetermined period of time.

Benchmark Data

In some embodiments, there is provided a method for generating benchmark data. By segmenting data by the context of normative metadata we can create multiple dimensions of response which can be aggregated using algorithms or machine learning to create a valuable predictor of the success of the media in the real world.

In some embodiments a system for comparing segmented data to create a rating which predicts the success of displayed media is provided. In this context, success is defined as a judgement by expert knowledge or through business statistics such as return on investment.

The segmenting of data is performed by collecting items tagged with common metadata tags and analyzing the items in combination with biometric data such as eye tracking. By combining the biometric data with the tagged items, a normative database may be built.

Once the normative database exists, a rating system may be defined by analyzing the collected data. This rating system may utilize mathematical modelling such as least squares, support vector machines, bayesian probability and other mathematical techniques.

Websockets

In some embodiments, there exists a method for efficient gathering of biometric data from a computing device. The method comprises the utilisation of websockets or similar mechanism for executing code to interface with a biometric data provider such as an eye tracker or webcam. In this manner, the websocket may be utilised in a website such that upon entry to the website a user is provided with an option to commence biometric data collection.

The code may automatically detect the presence of a biometric data collection device, and the use of a Javascript library which allows for easy access to hardware and software eye trackers.

Face Tracking

In some embodiments, there exists a method for determining information regarding a user by facial identification and tracking. According to this method information such as age and sex may be estimated by known techniques for classifying facial features. Images may be captured by any form of imaging device provided in or attached to a computer, such as a webcam for example. Once age and/or sex of a user are estimated, targeted advertisements may be shown, this may be enacted by inserting age and/or sex as metadata in any information collected.

Head Movement Compensation

In some embodiments, to account for changes in a user's head position it is possible to perform calibration sequences before display of stimuli and after display of stimuli. By calibrating eye position before and after display of stimuli, adjustments can be made in gathered gaze data to compensate for changes in head position.

Multiple Step Calibration, Validation and Determination of Quality

In some embodiments, a biometric data provider such as an eye tracker or webcam is calibrated or validated at multiple points to determine whether the data obtained by the provider is of sufficient quality.

This multiple point calibration or validation is performed in the following manner (in the case of an eye tracking device):

1. Prior to a stimulus or media item being displayed to a user, a calibration is performed for calibrating a user's determined gaze location against an expected gaze location.

2. During display of a stimulus or media item, a determination of the quality of eye tracking data obtained by the eye tracking device is made.

3. In between display of multiple stimulus or media items, a validation that the user's head is within the bounds of a predetermined optimal area is made.

4. After conclusion of displaying all stimuli or media items, a validation is performed that the user's determined gaze location is of sufficient accuracy.

By combining all of the above calibration and validation steps, a determination may be made as to whether the viewing of the stimuli or media items was of sufficient quality so as to represent valid data.

Value: Any one of these dimensions may not be enough to perform quality assessment which results is high quality data in the real world.

Generate Automatic AOIs by Parsing the Dom Tree Structure

In some embodiments, there is provided a method for automatically examining a content holder such as a web page for determining parts of the holder to define as an area of interest. An area of interest is an area in which it is desirable to measure biometric data relative to, for example gaze information. An area of interest may be an advertisement, image, video or the like.

In some embodiments, the method may be instituted by analyzing the Document Object Model (DOM) structure of a website. In this way, the DOM tree structure is analyzed to locate predefined keywords such as “ad” or the like, upon location of a predefined keywords software according to some embodiments of the present invention may automatically tag the items associated with those keywords as an area of interest.

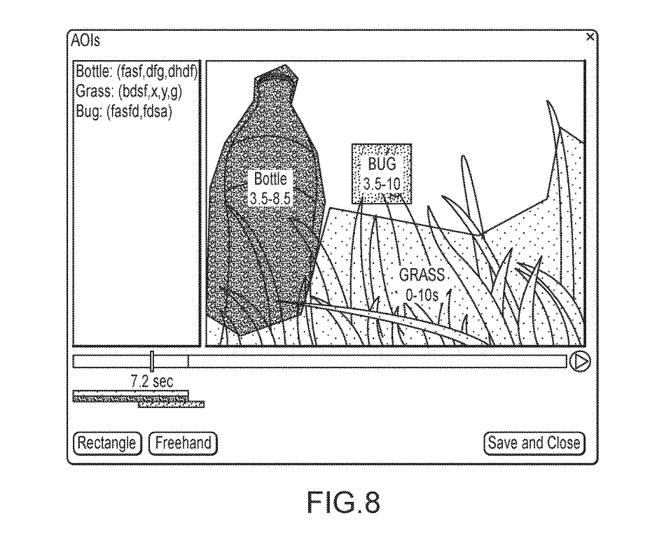

FIG. 8 shows a media file having multiple AOIs defined and overlayed.

In order to utilize areas of interest, it is preferable that the following method be performed:
1. Determine the layout and placement of areas of interest, such as advertisements or other items displayed on a display
2. Determine a person's gaze direction relative to the display
3. Determine when the person's gaze direction is directed towards an element of interest on the display
4. Collect information determined in step 3 for analysis. Information may include gaze direction, pupil dilation, eye positions, blink frequency, color of the Iris, heart rate, ECG, EEG or other sensor data.
5. Upload collected information to servers online
6. Use said information, often in aggregated format, for analysis, presentation, billing or targeting of advertisement or dynamic display of advertising

Facial Coding of Emotions with Processing in the Cloud Using Images Collected Via Device Camera

In some embodiments, there is provided a method for processing captured images in a location remote from that in which they were captured.

Images may be captured via a dedicated image capture device located in or connected to a computing device, the captured images may be sent via a communication medium such as the internet to a remote computing device or network of remote computing devices. The remote computing device processing the images analyzes the images to identify facial features and translates those facial features into a determination of emotion. The determination of emotion may be matched to media or stimuli that was viewed at the time of the capturing of the image to judge a person's emotional reaction to the media or stimuli. There exists many methods for facial feature extraction and analysis to determine emotion and any are suitable for embodiments of the present invention as would be understood by a person skilled in the art.

In some embodiments of the invention, some basic analysis of the captured images may be performed by the computing device performing the capturing so as to improve the speed at which emotions can be determined.

Cloud Based Collection

In some embodiments, there is a method provided for performing collection of biometric data relative to displayed content without the need for installing dedicated software for the task.

In some embodiments, a web based interface is provided for collecting biometric data such as gaze information is provided whereby the settings of the collection of data are chosen based on the context of the desired results. For example, if it is desirable to determine the total number of hits to a website the settings for the biometric data collection will be altered to allow for the generation of a transparency map.

In some embodiments, a web based interface is provided for collecting biometric data such as gaze information presents questions to a user where the answers dictate the settings of the collection of biometric data from the user. In other words, an interview based technique is used whereby the user may answer “yes” or “no” to questions designed to streamline the collection of biometric data from the user.

In some embodiments, a web based interface is provided for collecting biometric data such as gaze information may be integrated with third party surveys and the like. This may be implemented via URL redirection, javascript snippets or any other known method for directing or loading information external to a website. In this manner, a third party may automatically include collection of biometric data in their own website.

In some embodiments, a web based interface is provided for collecting biometric data such as gaze information is provided whereby scaling the amount of user's from which biometric data is collected is convenient. By utilising a web based interface, the number of users participating in the collection of biometric data may scale from a low to high number in a straight forward manner. Software may then analyze the quality of the data collected so as to isolate only data of sufficient quality to be included in a study of the data.

In some embodiments n, a web based interface is provided for collecting biometric data such as gaze information allows for the creation of a study of biometric data to be created by a first person and then delivered to a second person for performance of the study. The use of a web based interface means the first and second persons do not require specific software, but rather can access the study from any computing device equipped with a web browser and connected to the internet.

Report Collaboration Tools

In some embodiments, there is provided a method for collaborating on the presentation of conclusions from biometric studies. The collaboration may be performed by providing dynamically generated links to summaries of the biometric data that may be accessed by multiple people simultaneously. Depending on settings, these people may be able to comment on the biometric data, annotate the data, overlay visualizations across the data or export the data in predetermined formats such as powerpoint, pdf, graphs, spreadsheets and the like.

Gaze Based Pattern or Profiling

In some embodiments, the display of media or stimuli may be altered based on received biometric data may be provided. It may be determined from biometric data that a user is paying attention to a specific displayed media item or stimulus and the displayed media or stimulus may then be altered. The alteration of the stimulus or media item may be a change in the size, shape, location or content of the media item or stimulus.

By way of example, in the case where the displayed media or stimulus is an advertisement and the biometric data is gaze information, the advertisement may initially display in a mode designed to gain attention such as by flashing, displaying bright colours or the like. Once the biometric data reveals that a user has looked at the advertisement, the advertisement may change to reveal a message or other item that an advertiser wishes to display to a user.

Alignment of Data

In some embodiments, biometric data sent via a communication medium such as the internet must be correctly aligned with the media that was displayed when the biometric data was recorded. This may be accomplished by the use of timestamping biometric data and tagging the data. Commonly tagged data may then be categorised together for convenient access and review via the cloud or other remote storage system.

Further, advertisements displayed on a website may comprise a visible or invisible tag with a URL or web location to which gaze information shall be uploaded. Upon a user gazing at an advertisement, the website or software will upload information relating to the user's gaze to the particular URL or web location.

In this manner, different advertisements may be tagged with different URLs or web locations and analysis of viewing information can be quickly and efficiently linked to individual advertisements or groups of advertisements.

By way of example, consider that a particular advertisement or group of advertisements is tagged with URL A, while advertisements for a competing product are tagged with URL B. Upon a user with the suitable software installed on their computing device, or suitably hosted online visiting participating website, each time the user gazes at an advertisement their gaze information such as gaze location, gaze duration and time stamps relating to their gaze information is uploaded to URL A or URL B. By visiting URL A or URL B it is easy to quickly see how many people have been gazing at a particular advertisement.

Exemplary Computing Device

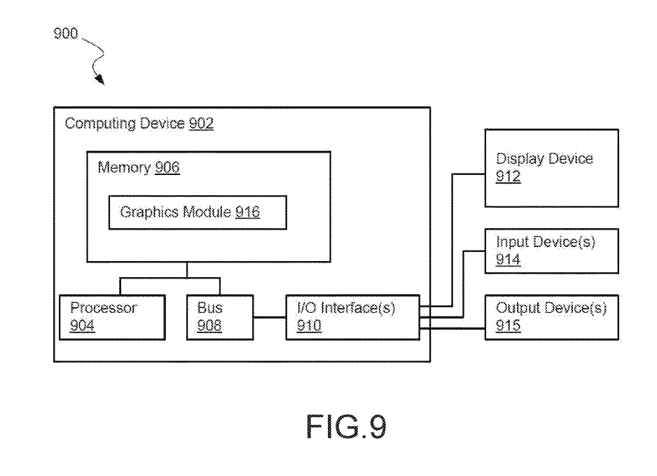

By way of example and not limitation, FIG. 9 is a block diagram depicting an example computing device 902 for implementing certain embodiments discussed herein. The computing device 902 can include a processor 904 that is communicatively coupled to a memory 906 and that executes computer-executable program instructions and/or accesses information stored in the memory 906. The processor 904 may comprise a microprocessor, an application-specific integrated circuit (“ASIC”), a state machine, or other processing device. The processor 904 can include any of a number of computer processing devices, including one. Such a processor can include or may be in communication with a computer-readable medium storing instructions that, when executed by the processor 904, cause the processor to perform the steps described herein.

The computing device 902 can also include a bus 908. The bus 908 can communicatively couple one or more components of the computing system 902. The computing device 902 can also include and/or be communicatively coupled to a number of external or internal devices, such as input or output devices. For example, the computing device 902 is shown with an input/output (“I/O”) interface 910, a display device 912, input device(s) 914 and output device(s) 915.

Non-limiting examples of a display device 912 include a screen integrated with the computing device 902, a monitor external and coupled with the computing system, etc. Non-limiting examples of input devices 914 include gaze detection devices, touch screens, touch pads, external mouse devices, microphones and/or other devices mentioned herein, etc. A non-limiting example of an output device 915 is an audio speaker. In some embodiments, the display device 912, the input device(s) 914 and the output device(s) 915 can be separate devices. In other embodiments, the display device 912 and at least some of the input device(s) 914 can be integrated in the same device. For example, a display device 912 may be a screen and an input device 914 may be one or more components providing eye-tracking and/or touch-screen functions for the display device, such as emitters for emitting light and/or cameras for imaging a user's eye(s) and/or a touch area, etc. The screen, input device components and any output device components may be integrated within the same housing or in other integrated configurations.

The computing device 902 can modify, access, or otherwise use electronic content. The electronic content may be resident in any suitable non-transitory computer-readable medium and execute on any suitable processor. In one embodiment, the electronic content can reside in the memory 906 at the computing system 902. In another embodiment, the electronic content can be accessed by the computing system 902 from a remote content provider via a data network.

The memory 906 can include any suitable non-transitory computer-readable medium. A computer-readable medium may include, but is not limited to, electronic, optical, magnetic, or other storage device capable of providing a processor with computer-readable instructions or other program code. Other examples comprise, but are not limited to, a floppy disk, CD-ROM, DVD, magnetic disk, memory chip, ROM, RAM, an ASIC, a configured processor, optical storage, magnetic tape or other magnetic storage, or any other medium from which a computer processor can read instructions. The instructions may comprise processor-specific instructions generated by a compiler and/or an interpreter from code written in any suitable computer-programming language, including, for example, C, C++, C#, Visual Basic, Java, Python, Perl, JavaScript, and ActionScript.

A graphics module 916 stored in the memory 906 can configure the processor 904 to prepare electronic content for rendering in a graphical interface and/or render the electronic content in the graphical interface. In some embodiments, the graphics module 916 can be a stand-alone application executed by the processor 904. In other embodiments, the graphics module 916 can be a software module included in or accessible by a separate application executed by the processor 904 that is configured to modify, access, or otherwise use the electronic content.

Embodiments of the invention have now been described in detail for the purposes of clarity and understanding. However, it will be appreciated that certain changes and modifications may be practiced within the scope of the disclosure.

What is claimed is:

1. A method for determining a relationship between biometric data and stimuli to reach a conclusion, the method comprising:
associating displayed stimuli with an identity label;
collecting biometric data relative to displayed stimuli;
attributing a rating to the displayed stimuli based on the biometric data; and
associating the rating with the identity label.

2. A method according to claim 1, wherein the collection of biometric data takes place via an eye tracking device.

3. A method according to claim 1, wherein the collection of biometric data takes place at multiple locations on a display.

4. A method according to claim 1, wherein the method further comprises receiving the identity label from a remote location.

5. A method according to claim 4, wherein the remote location is accessible via the Internet.

6. A method according to claim 1, wherein the displayed stimuli comprises at least one advertisement.

7. A method according to claim 1, wherein the displayed stimuli is displayed in a web browser.

8. A system for determining a relationship between biometric data and stimuli to reach a conclusion, the system comprising:
a computer configured for at least:
associating displayed stimuli with an identity label;
collecting biometric data relative to displayed stimuli;
attributing a rating to the displayed stimuli based on the biometric data; and
associating the rating with the identity label.

9. A system according to claim 8, wherein the collection of biometric data takes place via an eye tracking device.

10. A system according to claim 8, wherein the collection of biometric data takes place at multiple locations on a display.

11. A system according to claim 8, wherein the computer is further for at least receiving the identity label from a remote location.

12. A system according to claim 11, wherein the remote location is accessible via the Internet.

13. A system according to claim 8, wherein the displayed stimuli comprises at least one advertisement.

14. A system according to claim 8, wherein the displayed stimuli is displayed in a web browser.

15. A non-transitory machine readable medium having instructions stored thereon for determining a relationship between biometric data and stimuli to reach a conclusion, the instructions executable by one or more processors for at least:
associating displayed stimuli with an identity label;
collecting biometric data relative to displayed stimuli;
attributing a rating to the displayed stimuli based on the biometric data; and
associating the rating with the identity label.

16. The non-transitory machine readable medium of claim 15, wherein the collection of biometric data takes place via an eye tracking device.

17. The non-transitory machine readable medium of claim 15, wherein the collection of biometric data takes place at multiple locations on a display.

18. The non-transitory machine readable medium of claim 15, wherein the instructions are further executable for at least receiving the identity label from a remote location.

19. The non-transitory machine readable medium of claim 15, wherein the displayed stimuli comprises at least one advertisement.

20. The non-transitory machine readable medium of claim 15, wherein the displayed stimuli is displayed in a web browser.
